(19) United States
(12) Patent Application Publication
(10) Pub. No.: US 2026/0036739 A1
(43) Pub. Date: Feb. 5, 2026

(54) TUBULAR ANTI-RESONANT HOLLOW CORE FIBER WITH LOW VISCOSITY CLADDING MATERIAL

(71) Applicant: Lumentum Operations LLC, San Jose, CA (US)

(72) Inventors: Aljaž RAMŠAK, Ljubljana (SI); Gongwen ZHU, San Jose, CA (US); Peter JAKOPIC, Videm-Dobrepolje (SI); Filip SUHADOLC, Grosuplje (SI)

(21) Appl. No.: 18/978,408

(22) Filed: Dec. 12, 2024

Related U.S. Application Data
(60) Provisional application No. 63/677,240, filed on Jul. 30, 2024.

(51) Int. Cl. G02B 6/02

(52) U.S. Cl. CPC G02B 6/02328; G02B 6/02366

(57) ABSTRACT

An anti-resonant hollow core optical fiber includes a cladding having an outer circumferential surface and an inner circumferential surface that defines an interior volume, wherein the cladding is made of a cladding material; and a plurality of capillary tubes arranged within the interior volume, in a ring formation, wherein the plurality of capillary tubes are coupled to the inner circumferential surface of the cladding and define a hollow core. The plurality of capillary tubes are separated by gaps such that no capillary tube is in contact with another capillary tube. The plurality of capillary tubes are made of a tube material that is different from the cladding material. The cladding material has a first viscosity at a relative temperature. The tube material has a second viscosity at the relative temperature. The first viscosity is lower than the second viscosity.

### CROSS-REFERENCE TO RELATED APPLICATION

This Patent application claims priority to U.S. Provisional Patent Application No. 63/677,240, filed on Jul. 30, 2024, and entitled “TUBULAR ANTI-RESONANT HOLLOW CORE FIBER WITH LOW VISCOSITY CLADDING MATERIAL.” The disclosure of the prior Application is considered part of and is incorporated by reference into this Patent Application.

### TECHNICAL FIELD

The present disclosure relates generally to optical fibers, including anti-resonant hollow core optical fibers.

### BACKGROUND

A hollow-core fiber (HCF) is a type of optical fiber designed to guide light through an air-filled core rather than through a solid glass core, which is typical in conventional optical fibers. Unlike traditional optical fibers that have a solid glass core, HCFs have a central hollow core, usually surrounded by a microstructured cladding. HCFs can be split into two types based on a guidance mechanism. A first type of HCF includes photonic bandgap fibers to confine light by surrounding the hollow core with a periodic lattice of nodes. A second type of HCF (e.g., an anti-resonant hollow-core fiber (AR-HCF)) includes anti-resonant fibers that surround the core with a cladding of slender glass membranes of a specific thickness that are in anti-resonance with a core-guided light. The microstructured cladding of the AR-HCF may be made up of thin glass tubes or membranes arranged in a way that prevents light from escaping the hollow core through a mechanism called anti-resonance. The design of the microstructured cladding is such that the microstructured cladding creates an anti-resonant effect for certain wavelengths of light, effectively reflecting the light back into the hollow core. Thus, the anti-resonant effect minimizes light leakage and enhances transmission efficiency. AR-HCFs can support a wide range of wavelengths, making AR-HCFs suitable for various applications, including telecommunications, sensing, and high-power laser delivery.

### SUMMARY

In some implementations, an anti-resonant hollow core optical fiber includes a cladding having an outer circumferential surface and an inner circumferential surface that defines an interior volume, wherein the cladding is made of a cladding material; and a plurality of capillary tubes arranged within the interior volume, in a ring formation, wherein the plurality of capillary tubes are coupled to the inner circumferential surface of the cladding and define a hollow core, wherein the plurality of capillary tubes are separated by gaps such that no capillary tube is in contact with another capillary tube, wherein the plurality of capillary tubes are made of a tube material that is different from the cladding material, wherein the cladding material has a first viscosity at a relative temperature, wherein the tube material has a second viscosity at the relative temperature, and wherein the first viscosity is lower than the second viscosity.

In some implementations, an anti-resonant hollow core optical fiber includes a cladding having an outer circumferential surface and an inner circumferential surface that defines a first interior volume, wherein the cladding is made of a cladding material; an assembly hollow tube arranged within the first interior volume and coupled to the inner circumferential surface of the cladding, wherein the assembly hollow tube defines a second interior volume; and a plurality of non-contacting tubes arranged within the second interior volume, in a ring formation, wherein the plurality of non-contacting tubes are coupled to an interior surface of the assembly hollow tube and define a hollow core, wherein the plurality of non-contacting tubes are separated by gaps such that no non-contacting tube is in contact with another non-contacting tube, wherein the plurality of non-contacting tubes are made of a tube material that is different from the cladding material, wherein the cladding material has a first softening point, wherein the tube material has a second softening point, and wherein the first softening point is lower than the second softening point.

In some implementations, a method of manufacturing an anti-resonant hollow core optical fiber includes providing an assembly hollow tube having a first interior volume; forming a plurality of capillary tubes, the plurality of capillary tubes being made of a tube material; inserting the plurality of capillary tubes into the first interior volume of the assembly hollow tube to form a tube assembly, wherein the plurality of capillary tubes are coupled to an interior surface of the assembly hollow tube in an initial ring formation, and wherein the plurality of capillary tubes are separated by initial gaps such that no capillary tube is in contact with another capillary tube; providing a cladding having an outer circumferential surface with an initial outer circumferential dimension and an initial inner circumferential surface with an initial inner circumferential dimension, wherein the initial inner circumferential surface defines a second interior volume, and wherein the cladding is made of a cladding material that has a lower viscosity at a drawing temperature than the tube material; inserting the tube assembly into the second interior volume to form a fiber preform; and drawing the fiber preform from a furnace at the drawing temperature and at a drawing tension to form the anti-resonant hollow core optical fiber, wherein, in the anti-resonant hollow core optical fiber, the plurality of capillary tubes are arranged in a final ring formation to define a hollow core configured to confine light.

In some implementations, an anti-resonant hollow core optical fiber includes a cladding having an outer circumferential surface and an inner circumferential surface that defines an interior volume, wherein the cladding is made of a cladding material; and a plurality of circular capillary tubes arranged within the interior volume, in a ring formation, wherein the plurality of circular capillary tubes are coupled to the inner circumferential surface of the cladding and define a hollow core, wherein the plurality of circular capillary tubes are made of a tube material that is different from the cladding material, wherein the cladding material has a first viscosity at a relative temperature, wherein the tube material has a second viscosity at the relative temperature, and wherein the first viscosity is lower than the second viscosity.

### BRIEF DESCRIPTION OF THE DRAWINGS

FIG. 1 shows anti-resonant hollow core optical fiber according to one or more implementations.

FIGS. 2A-2C show a process flow for manufacturing an anti-resonant hollow core optical fiber.

FIG. 3 shows an example illustrating an initial configuration of an anti-resonant hollow core optical fiber and a final configuration of an anti-resonant hollow core optical fiber.

FIG. 4 shows an example illustrating an initial configuration of an anti-resonant hollow core optical fiber and a final configuration of an anti-resonant hollow core optical fiber.

FIG. 5 is a flowchart of an example process associated with tubular anti-resonant hollow core fiber with low viscosity cladding material.

### DETAILED DESCRIPTION

The following detailed description of example implementations refers to the accompanying drawings. The same reference numbers in different drawings may identify the same or similar elements.

AR-HCFs have many geometric variants defined by their cladding structure, such as Kagome and tubular designs. While the first AR-HCFs with a Kagome lattice had attenuations of the order of decibels per meter (dB/m), a significant improvement was achieved by imposing a hypocycloid (negative curvature) design. Despite the progress, Kagome designs suffer intrinsically from the presence of glass junctions in the cladding structure that compromise optical performance. At the glass junctions, a glass thickness is greater than in the connecting membranes. Therefore, these parts of the geometry introduce resonances that increase the loss of such fibers at multiple spectral locations within a transmission window. To eliminate the problem of connecting membranes, non-contacting tubular designs have been developed. The non-contacting tubular design and fabrication of the non-contacting tubular design is simpler than the design and fabrication of Kagome designs. Since a thickness of the cladding membrane is uniform, with no nodes or glass junctions, these fibers may provide broad and smooth transmission windows, which is beneficial for numerous applications. The tubular geometry has also paved the way for a new generation of hollow-core fibers with one or more membranes aligned azimuthally. These new anti-resonant fibers have the potential to challenge conventional fibers in many applications.

To obtain good light guiding properties, it is beneficial to have tubes/capillaries arranged within an interior volume of a final fiber as close as desired, but not touching to reduce losses. The drawing process usually begins with a glass preform, which may be a macroscopic assembly from which fiber is drawn. To prevent a collapse of the capillaries and/or the glass preform during the drawing process, pressure (e.g., overpressure) is maintained in the capillaries and sometimes also in a hollow core defined by the capillaries. One of the challenges in manufacturing such tubular designs is to prevent the contact of the capillaries during the drawing process (e.g., during a middle of the drawing process) while trying to obtain the desired distance or spacing between capillaries in the final fiber. This phenomenon is commonly referred to as “the mid-draw contact” or MDC, as the phenomenon occurs during the middle of the drawing process. Not only does MDC cause the capillaries to touch, which causes losses, MDC typically causes the capillaries to deform and become non-circular due to the contact with other capillaries, which may further increase losses. In some implementations, the capillaries may be circular in order to enhance an anti-resonant condition by which the capillaries guide light in the hollow core and to reduce losses. In some implementations, other shapes (cross-sections) may be desired. Thus, MDC that causes capillary tube deformation (e.g., to be deformed from a desired shape) should be avoided.

Some implementation described herein provide an AR-HCF with capillary tubes arranged that define a hollow core for guiding light. The AR-HCF may include a cladding that defines an interior volume and that surrounds the capillary tubes and the hollow core. Thus, the capillary tubes may be arranged within the interior volume defined by the cladding. The capillary tubes may be arranged in a ring formation such that the capillary tubes define the hollow core. The hollow core may function as a light guiding region (or a confinement region) within the interior volume. For example, the capillary tubes may be arranged along an inner circumferential surface of the cladding. The capillary tubes may be circular (e.g., having a circular profile or cross-section) to enhance an anti-resonant condition by which the capillary tubes guide light in the hollow core and to reduce losses. The hollow core may be defined by negative curvatures of the capillary tubes, the negative curvatures facing inwardly toward a center of the hollow core. For example, the capillary tubes may be referred to as “negative curvature fibers” because the curvature of the hollow core boundary, defined by the capillary tubes, is negative in a geometric sense. Instead of being circular, the hollow core boundary resembles a flower turned inside out.

A curved geometry of the capillary tubes help to prevent light from escaping the hollow core by increasing an effective reflectivity of the core walls. A thickness of the capillary tubes may be designed to achieve anti-resonance, with the negative curvatures serving as an additional feature that enhances the anti-resonant condition, thereby reducing losses. Accordingly, the capillary tubes may be anti-resonant tubes that are configured to guide the light based on an anti-resonant effect provided by the capillary tubes (e.g., based on an anti-resonant effect which occurs in the capillary tubes). The anti-resonant effect may be provided, in part, by the negative curvatures of the capillary tubes.

The cladding may be made of a cladding material that is different from a tube material used for the capillary tubes. The cladding material may have a first viscosity at a relative temperature (e.g., a drawing temperature), the tube material may have a second viscosity at the relative temperature, and the first viscosity may be lower than the second viscosity. Thus, the cladding may have a lower viscosity at drawing temperature than the capillary tubes. The difference in viscosity, with the cladding having the lower viscosity, may help to prevent mid-draw contact of the capillary tubes during a drawing process.

Consider a first AR-HCF that uses a same material for both the cladding material and the tube material (e.g., same viscosity), and a second AR-HCF that has cladding with a lower viscosity compared to the capillary tubes. Further consider that the first AR-HCF and the second AR-HCF have a same initial (pre-draw) configuration or geometry, with same sized cladding, same sized capillary tubes, same number of capillary tubes, same sized hollow core, and same spacing between capillary tubes. Further consider using a same drawing tension from a preform for both the first AR-HCF and the second AR-HCF during a drawing process. The difference in viscosity, with the cladding having the lower viscosity, allows smaller spacing or distances between the capillary tubes to be achieved for the final fiber of the second AR-HCF (e.g., at a same drawing tension) than the first AR-HCF. Thus, the second AR-HCF has better light guiding properties than the first AR-HCF due to the smaller spacing between the capillary tubes.

Consider again a first AR-HCF that uses a same material for both the cladding material and the tube material (e.g., same viscosity), and a second AR-HCF that has cladding with a lower viscosity compared to the capillary tubes. Further consider that the first AR-HCF and the second AR-HCF have a same initial (pre-draw) configuration or geometry, with same sized cladding, same sized capillary tubes, same number of capillary tubes, same sized hollow core, and same spacing between capillary tubes. Further consider using different drawing tensions from a preform for the first AR-HCF and the second AR-HCF during a drawing process, with a significantly lower drawing tension being used to draw the second AR-HCF than to draw the first AR-HCF. The difference in viscosity, with the cladding having the lower viscosity, allows a same spacing or distance between the capillary tubes to be achieved for the final fiber of the second AR-HCF compared to the spacing or distance between the capillary tubes achieved for the final fiber of the first AR-HCF. In other words, despite using a significantly lower drawing tension for drawing the second AR-HCF, the first AR-HCF and the second AR-HCF have a same final configuration or geometry. Higher drawings tensions may cause a fiber to break during the drawing process due to higher stress, or lead to diminished fiber strength (weakened fibers) of a fiber such that the fiber is more susceptible to failing during use. Thus, lowering the drawing tension may increase a production yield in manufacturing AR-HCFs.

The drawing tension used for the second AR-HCF may be customized such that drawing tension is lowered enough to avoid breakage, but maintained high enough to reduce the spacing between the capillary tubes to provide better light guiding properties with lower losses. Thus, using a lower viscosity material for the cladding relative to the capillary tubes may provide more flexibility during the manufacturing process. Moreover, parameters may be set so that mid-draw contact is avoided while minimizing a spacing between capillary tubes.

Using the lower viscosity material for the cladding relative to the capillary tubes may enable more control during a drawing process to control a spacing between the capillary tubes that is produced during or resultant from a middle of the drawing process. While it may be preferred to have the capillary tubes not touching in a final fiber configuration (e.g., to reduce losses), some implementations may have the capillary tubes slightly touching in the final fiber configuration. For example, the spacing between the capillary tubes during the middle of the drawing process may be designed such that the capillary tubes slightly touch at an end of the drawing process. The capillary tubes may slightly touch in a way that does not cause the capillary tubes to deform. In other words, in the final fiber configuration, the capillary tubes may slightly touch in a way that a circular shape (cross-section) of the capillary tubes is maintained, despite the contact occurring between adjacent capillary tubes at the end of the drawing process. The pressure in the capillary tubes may remain constant during the draw process, with the same pressure maintained along the entire length from the preform to the fiber, which may be controlled to regulate a final spacing between capillary tubes and/or to cause the capillary tubes to slightly touch without causing deformation.

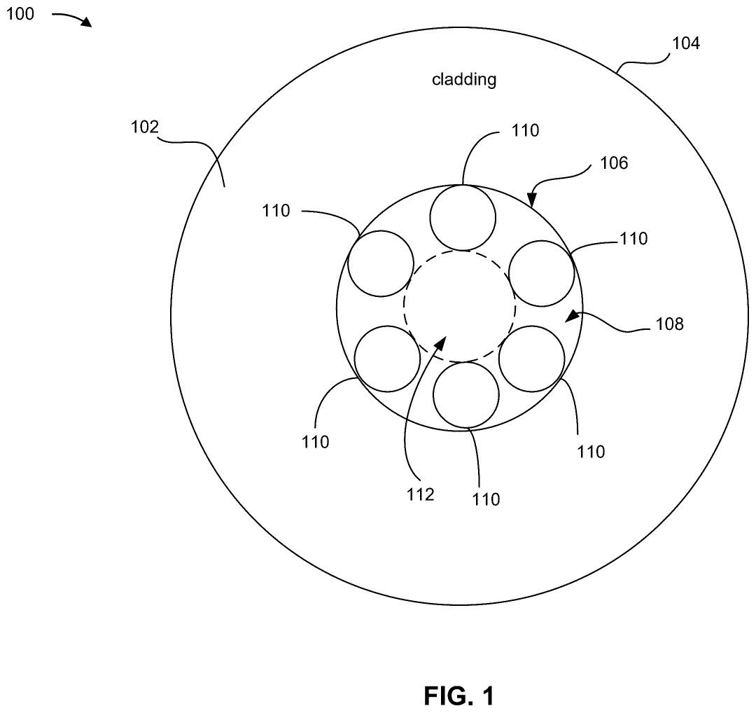

FIG. 1 shows anti-resonant hollow core optical fiber 100 according to one or more implementations. The anti-resonant hollow core optical fiber 100 may correspond to a middle of a draw configuration, after a middle of a drawing process is complete, or a final fiber configuration, after the full drawing process is complete. The anti-resonant hollow core optical fiber 100 may include a cladding 102 (e.g., a cladding tube) having an outer circumferential surface 104 and an inner circumferential surface 106 that defines an interior volume 108. The cladding 102 is made of a cladding material (of lower viscosity), such as doped silica glass. In some implementations, the cladding may be made of two or more materials used to form two or more concentric claddings or cladding layers, at least one of which is made of a cladding material of lower viscosity, such as doped silica glass. The anti-resonant hollow core optical fiber 100 may include a plurality of capillary tubes 110 (e.g., a plurality of circular non-contacting tubes) arranged within the interior volume 108, in a ring formation. Initially, the interior volume 108 may be hollow, prior to insertion of the capillary tubes 110. The plurality of capillary tubes 110 may be coupled to the inner circumferential surface 106 of the cladding 102. The plurality of capillary tubes 110 may be separated by gaps such that no capillary tube 110 is in contact with another capillary tube 110. Put another way, no mid-draw contact occurs during a drawing process. The capillary tubes may be circular (e.g., having a circular profile or cross-section) to enhance an anti-resonant condition by which the capillary tubes guide light in a hollow core 112 and to reduce losses.

The plurality of capillary tubes 110 may be made of a tube material, such as a pure silica glass, that is different from the cladding material (e.g., different from the cladding material of lower viscosity). The cladding material may have a first viscosity at a relative temperature (e.g., a drawing temperature), the tube material may have a second viscosity at the relative temperature, and the first viscosity may be lower than the second viscosity, which enables mid-draw contact to be avoided. For example, the cladding material may have a first softening point, the tube material may have a second softening point, and the first softening point is lower than the second softening point. The lower viscosity/softening point of the cladding material relative to the tube material may enable the cladding to collapse onto the plurality of capillary tubes 110 during a drawing process or prior to the draw process.

The plurality of capillary tubes 110 may define the hollow core 112, which may be or may otherwise include a light guiding region and/or a light confinement region. The hollow core 112 may be defined by negative curvatures of the plurality of capillary tubes 110, the negative curvatures facing inwardly toward a center of the interior volume 108 (e.g., of the hollow core 112). The plurality of capillary tubes 110 may be substantially equidistant from each other. The plurality of capillary tubes 110 may confine and guide light within the hollow core 112. Thus, the plurality of capillary tubes 110 may be anti-resonant tubes that are configured to guide the light based on an anti-resonant effect that occurs in the plurality of capillary tubes 110.

In some implementations, the anti-resonant hollow core optical fiber 100 may include an assembly hollow tube (not illustrated) arranged within the interior volume 108 and coupled to the inner circumferential surface 106 of the cladding. The assembly hollow tube may define an interior volume. The plurality of capillary tubes 110 may be arranged within the interior volume of the assembly hollow tube and may be coupled to an interior surface of the assembly hollow tube. The assembly hollow tube may be made of a material that has a higher viscosity (e.g., a higher softening point) at the relative temperature than the cladding material. For example, the assembly hollow tube may be made of the tube material (e.g., a same material used from the plurality of capillary tubes 110). In some implementations, the assembly hollow tube may be made of a cladding material (e.g., the cladding material of lower viscosity). Thus, prior to the drawing process, the plurality of capillary tubes 110 may be preassembled into the assembly hollow tube, and the assembly hollow tube may subsequently be inserted into the interior volume 108 of the cladding 102. A fiber assembly or a fiber preform, including the cladding 102, the assembly hollow tube, and the plurality of capillary tubes 110 may then be drawn during the drawing process to form the final fiber.

Using a lower viscosity material for the cladding 102 relative to the capillary tubes 110 may enable more control during the drawing process to control a spacing between the capillary tubes 110 that is produced during or resultant from the middle of the drawing process. While it may be preferred to have the capillary tubes 110 not touching in the final fiber configuration (e.g., to reduce losses), some implementations may have the capillary tubes 110 slightly touching in the final fiber configuration. For example, the spacing between the capillary tubes 110 during the middle of the drawing process may be designed such that the capillary tubes 110 slightly touch at an end of the drawing process. The capillary tubes 110 may slightly touch in a way that does not cause the capillary tubes 110 to deform. In other words, in the final fiber configuration, the capillary tubes 110 may slightly touch in a way that a circular shape (cross-section) of the capillary tubes 110 is maintained, despite the contact occurring between adjacent capillary tubes 110 at the end of the drawing process. An internal pressure in the capillary tubes may be controlled to remain constant during the draw process, with the same pressure maintained along the entire length from the preform to the fiber. In some implementations, the internal pressure may be controlled to regulate a final spacing between capillary tubes 110 and/or to cause the capillary tubes 110 to slightly touch without causing deformation.

As indicated above, FIG. 1 is provided as an example. Other examples may differ from what is described with regard to FIG. 1.

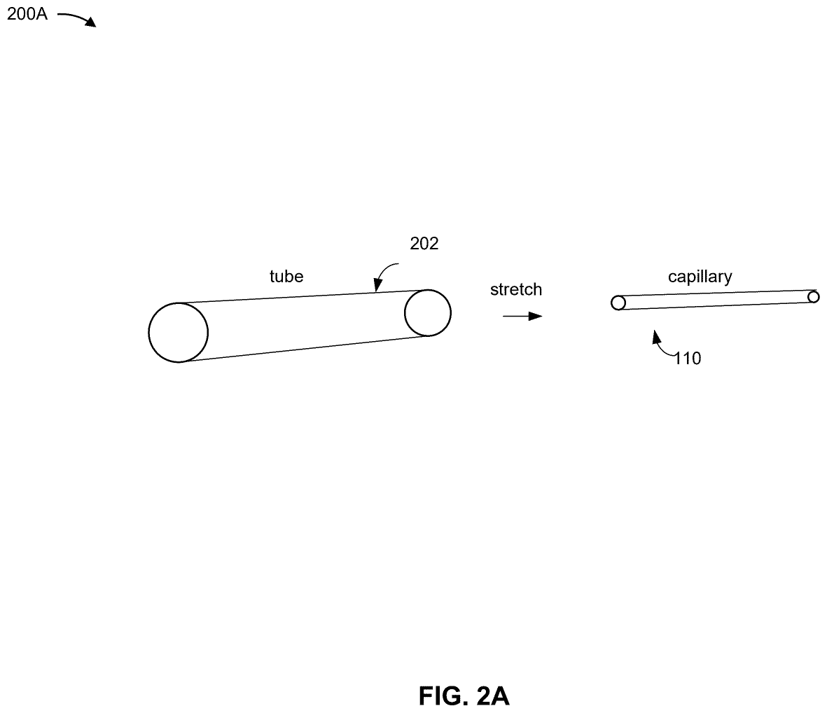

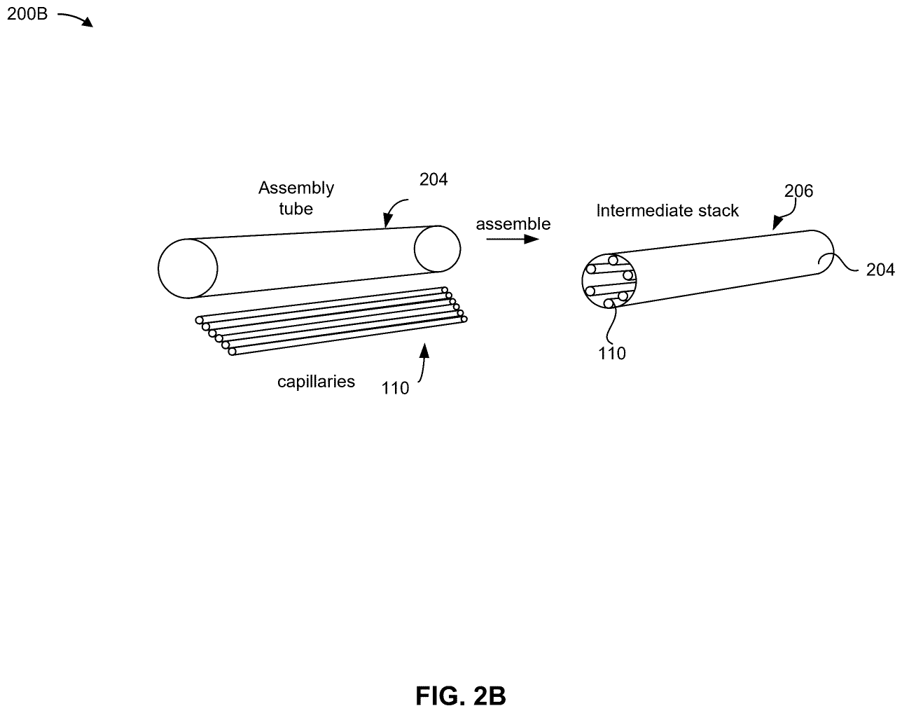

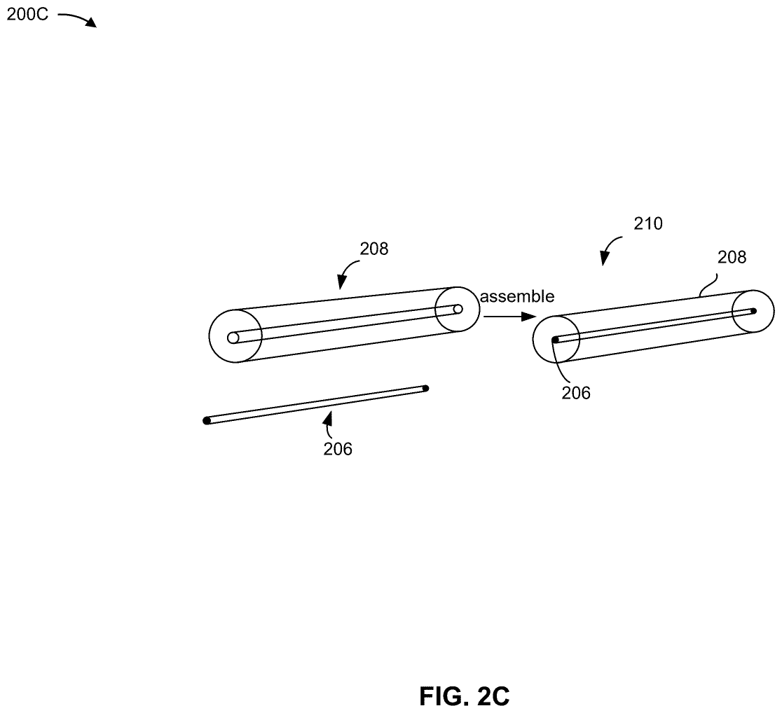

FIGS. 2A-2C show a process flow for manufacturing an anti-resonant hollow core optical fiber. For example, the process flow may be used to make the anti-resonant hollow core optical fiber 100 described in connection with FIG. 1.

FIG. 2A shows a process 200A that includes forming a plurality of capillary tubes 110. For example, an initial tube 202 made of a tube material may be stretched to form a capillary tube 110. The processed may be repeated to form the plurality of capillary tubes 110. Each capillary tube 110 may have a circular cross-section that, in a final fiber configuration, aids in guiding light and reduces losses.

FIG. 2B shows a process 200B that includes providing an assembly hollow tube 204 having a first interior volume, and inserting the plurality of capillary tubes 110 into the first interior volume of the assembly hollow tube 204 to form a tube assembly 206. The assembly hollow tube 204 may be made of a material that has a higher viscosity (e.g., a higher softening point) at the relative temperature than the cladding material. For example, the assembly hollow tube may be made of the tube material (e.g., a same material used from the plurality of capillary tubes 110). In some implementations, the assembly hollow tube 204 may be made of a cladding material. The plurality of capillary tubes 110 may be coupled to an interior surface of the assembly hollow tube 204 in an initial ring formation. The plurality of capillary tubes 110 may be separated by initial gaps such that no capillary tube 110 is in contact with another capillary tube 110.

FIG. 2C shows a process 200C that includes providing a cladding 208 (e.g., a cladding tube) having an outer circumferential surface with an initial outer circumferential dimension and an initial inner circumferential surface with an initial inner circumferential dimension. The initial inner circumferential surface may define a second interior volume configured for receiving the tube assembly 206. The cladding 208 may be made of a cladding material that has a lower viscosity at a drawing temperature than the tube material. In some implementations, the cladding may be made of two or more materials used to form two or more concentric claddings or cladding layers, at least one of which is made of a cladding material of lower viscosity, such as doped silica glass. Thus, at least part of the part of the cladding 208 (e.g., the cladding tube) is of lower viscosity than the plurality of capillary tubes 110.

The process 200C may further include inserting the tube assembly 206 into the second interior volume of the cladding 208 to form a fiber preform 210, and drawing the fiber preform from a furnace at the drawing temperature and at a drawing tension to form the anti-resonant hollow core optical fiber (e.g., anti-resonant hollow core optical fiber 100). Drawing the fiber preform 210 may cause the cladding 208 (e.g., the second interior volume of the cladding 208) to partially collapse inward in a radial direction, bringing the capillary tubes 110 closer together. In the final fiber configuration of the anti-resonant hollow core optical fiber (e.g., in the final fiber), the plurality of capillary tubes 110 may be arranged in a final ring formation that defines a hollow core configured to guide and confine light, similar to the hollow core 112 described in connection with FIG. 1.

In some implementations, the plurality of capillary tubes 110 of the anti-resonant hollow core optical fiber may be separated by final gaps such that no capillary tube 110 is in contact with another capillary tube 110. In addition, the final gaps are smaller than the initial gaps. In the final fiber configuration of the anti-resonant hollow core optical fiber (e.g., in the final fiber), the plurality of capillary tubes 110 may have a circular cross-section.

In some implementations, the plurality of capillary tubes 110 of the anti-resonant hollow core optical fiber may slightly touch or be in slight contact with each other. In the final fiber configuration of the anti-resonant hollow core optical fiber (e.g., in the final fiber), the plurality of capillary tubes 110 may have a circular cross-section, despite being in slight contact with each other. Thus, any contact between the plurality of capillary tubes 110 must be small enough to maintain a circular profile of each of the capillary tubes 110, without causing deformation resulting in a non-circular profile.

During drawing the fiber preform, a difference in viscosity, at the drawing temperature, between the cladding material and the tube material may prevent the plurality of capillary tubes 110 from coming into contact with each other. Additionally, drawing the fiber preform may include maintaining an overpressure in the plurality of capillary tubes 110 to prevent a collapse of the plurality of capillary tubes 110. In some implementations, drawing the fiber preform may include maintaining an overpressure in the hollow core or in the first interior volume to prevent the mid-draw contact of the plurality of capillary tubes 110.

After drawing the fiber preform, the outer circumferential surface of the cladding 208 may have has a final outer circumferential dimension that is smaller than the initial outer circumferential dimension, and a final inner circumferential dimension that is smaller than the initial inner circumferential dimension.

The plurality of capillary tubes 110 of the anti-resonant hollow core optical fiber may be configured to guide light within the hollow core. The hollow core may be defined by negative curvatures of the plurality of capillary tubes 110, where the negative curvatures face inwardly toward a center of the hollow core.

In some implementations, the plurality of capillary tubes 110 may be inserted or assembled into the cladding 208 (e.g., a hollow cladding tube) without using the assembly hollow tube 204, as similarly depicted in FIG. 1. Thus, the fiber preform 210 may be composed of the cladding 208 and the plurality of capillary tubes 110.

As indicated above, FIGS. 2A-2C are provided as examples. Other examples may differ from what is described with regard to FIGS. 2A-2C.

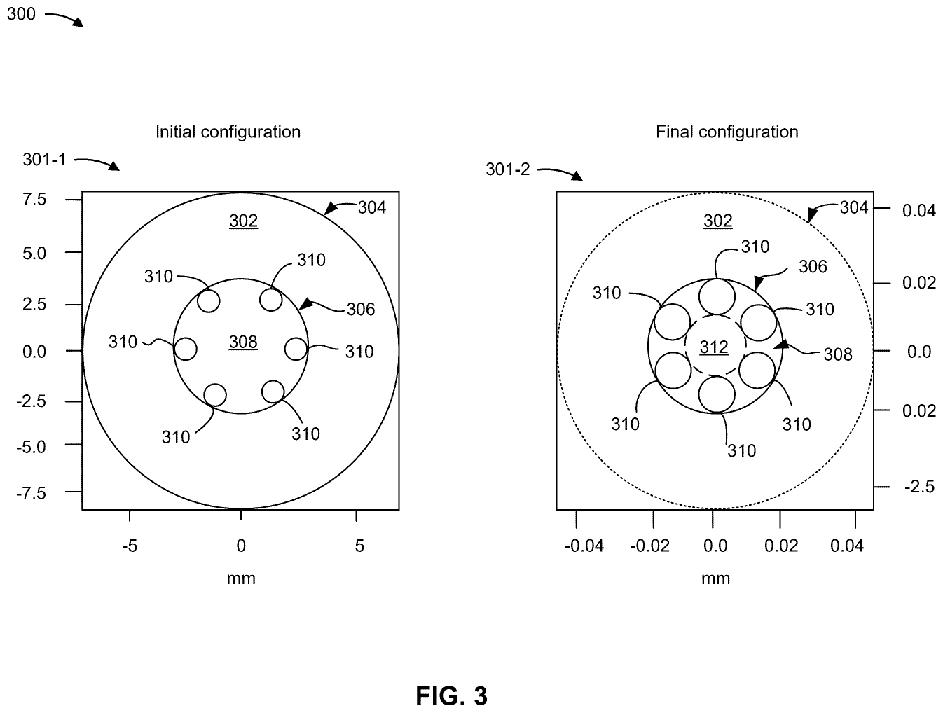

FIG. 3 shows an example 300 illustrating an initial configuration of an anti-resonant hollow core optical fiber and a final configuration of an anti-resonant hollow core optical fiber. For example, the initial configuration may be a configuration of a fiber preform 301-1 prior to a drawing process and the final configuration may be a configuration of a final fiber 301-2 after the drawing process. The fiber preform 301-1 may include a cladding 302 having an outer circumferential surface 304 and an inner circumferential surface 306 that defines an interior volume 308. Additionally, the fiber preform 301-1 may include a plurality of capillary tubes 310 arranged within the interior volume 308, in a ring formation. The plurality of capillary tubes 310 may be coupled to the inner circumferential surface 306 of the cladding 302. The plurality of capillary tubes 310 may be separated by initial gaps such that no capillary tube 310 is in contact with another capillary tube 310. The cladding 302 and the capillary tubes 310 may be made of a same material, such as pure silica glass. Thus, the cladding 302 and the capillary tubes 310 may have a same viscosity and softening point.

The fiber preform 301-1 may be drawn from a furnace at a drawing temperature and with a drawing tension to form the final fiber 301-2. The final fiber 301-2 may have a hollow core 312 defined by the capillary tubes 310. The capillary tubes 310 may be separated by final gaps such that no capillary tube 310 is in contact with another capillary tube 310.

As indicated above, FIG. 3 is provided as an example. Other examples may differ from what is described with regard to FIG. 3.

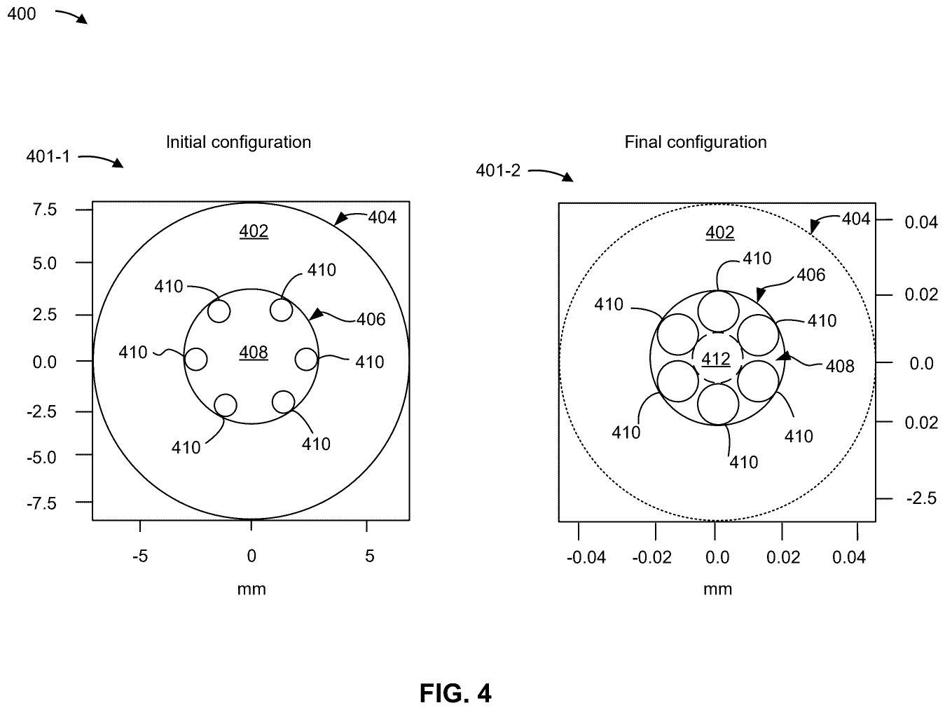

FIG. 4 shows an example 400 illustrating an initial configuration of an anti-resonant hollow core optical fiber and a final configuration of an anti-resonant hollow core optical fiber. For example, the initial configuration may be a configuration of a fiber preform 401-1 prior to a drawing process and the final configuration may be a configuration of a final fiber 401-2 after the drawing process. The final fiber 401-2 may be similar to the anti-resonant hollow core optical fiber 100 described in connection with FIG. 1.

The fiber preform 401-1 may include a cladding 402 having an outer circumferential surface 404 and an inner circumferential surface 406 that defines an interior volume 408. Additionally, the fiber preform 401-1 may include a plurality of capillary tubes 410 arranged within the interior volume 408, in a ring formation. The plurality of capillary tubes 410 may be coupled to the inner circumferential surface 406 of the cladding 402. The plurality of capillary tubes 410 may be separated by initial gaps such that no capillary tube 410 is in contact with another capillary tube 410. The fiber preform 401-1 may have a same initial (pre-draw) configuration or geometry as the fiber preform 301-1. However, the cladding 402 and the capillary tubes 410 may be made of different materials, similar to the anti-resonant hollow core optical fiber 100 described in connection with FIG. 1. Thus, the cladding 402 may be made of a cladding material that has a lower viscosity (e.g., lower softening point) than a tube material used for the capillary tubes 410.

The fiber preform 401-1 may be drawn from a furnace at a drawing temperature and with a drawing tension to form the final fiber 401-2. For example, the fiber preform 401-1 may be drawn from a furnace at same drawing temperature and with a same drawing tension used for drawing the fiber preform 301-1 described in connection with FIG. 3

The final fiber 401-2 may have a hollow core 412 defined by the capillary tubes 410, similar to the hollow core 112 described in connection with FIG. 1. The capillary tubes 410 may be separated by final gaps such that no capillary tube 410 is in contact with another capillary tube 410. Despite applying the same drawing temperature and the same drawing tension to both fiber preforms 301-1 and 401-1, the final gaps between capillary tubes 410 may be smaller than the final gaps between capillary tubes 310. When using the same drawing temperature, drawing pressure, and drawing tension settings for both fiber preforms 301-1 and 401-1, the difference in viscosity of the materials in the fiber preform 401-1, with the cladding 402 having the lower viscosity than the capillary tubes 410, may allow smaller spacing or distances between the capillary tubes 410 to be achieved for the final fiber 410-2 than for the final fiber 301-2. Thus, the final fiber 410-2 has better light guiding properties than the final fiber 301-2 due to the smaller spacing between the capillary tubes 410 than between the capillary tubes 310.

The drawing tension used for the final fiber 410-2 may be customized such that drawing tension is lowered enough to avoid breakage, but maintained high enough to reduce the spacing between the capillary tubes 410 to provide better light guiding properties with lower losses. Thus, using a lower viscosity material for the cladding 402 relative to the capillary tubes 410 may provide more flexibility during the manufacturing process. Moreover, parameters may be set so that mid-draw contact is avoided while minimizing a spacing between capillary tubes 410. Furthermore, lowering the drawing tension may increase a production yield in manufacturing AR-HCFs by reducing a number of fiber faults caused by higher tension.

As indicated above, FIG. 4 is provided as an example. Other examples may differ from what is described with regard to FIG. 4.

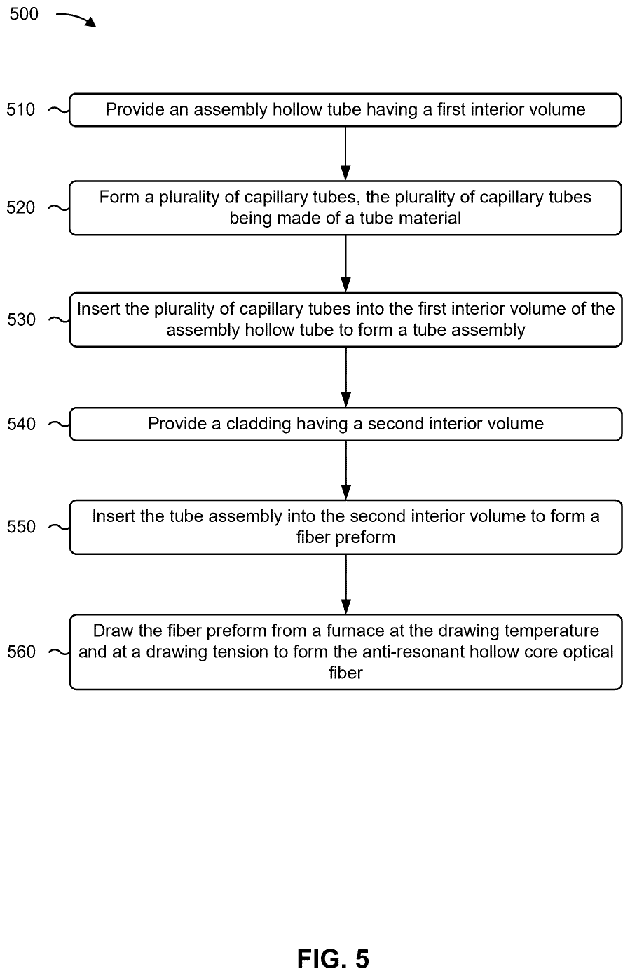

FIG. 5 is a flowchart of an example process 500 associated with tubular anti-resonant hollow core fiber with low viscosity cladding material. In some implementations, one or more process blocks of FIG. 5 are performed by an optical fiber manufacturing system. In some implementations, one or more process blocks of FIG. 5 are performed by another device or a group of devices separate from or including the optical fiber manufacturing system.

Additionally, or alternatively, one or more process blocks of FIG. 5 may be performed by one or more components of the optical fiber manufacturing system, such as a controller that regulates a drawing temperature, a drawing pressure, and a drawing tension during a drawing process.

As shown in FIG. 5, process 500 may include providing an assembly hollow tube having a first interior volume (block 510). For example, the optical fiber manufacturing system may provide the assembly hollow tube having the first interior volume.

As further shown in FIG. 5, process 500 may include forming a plurality of capillary tubes, the plurality of capillary tubes being made of a tube material (block 520). For example, the optical fiber manufacturing may form a plurality of capillary tubes, the plurality of capillary tubes being made of a tube material, as described above.

As further shown in FIG. 5, process 500 may include inserting the plurality of capillary tubes into the first interior volume of the assembly hollow tube to form a tube assembly (block 530). The plurality of capillary tubes may be coupled to an interior surface of the assembly hollow tube in an initial ring formation. The plurality of capillary tubes may be separated by initial gaps such that no capillary tube is in contact with another capillary tube. For example, the optical fiber manufacturing system may insert the plurality of capillary tubes into the first interior volume of the assembly hollow tube to form the tube assembly, as described above.

As further shown in FIG. 5, process 500 may include providing a cladding having an outer circumferential surface with an initial outer circumferential dimension and an initial inner circumferential surface with an initial inner circumferential dimension (block 540). The initial inner circumferential surface may define a second interior volume. The cladding may be made of a cladding material that has a lower viscosity at a drawing temperature than the tube material. For example, the optical fiber manufacturing system may provide the cladding, as described above.

As further shown in FIG. 5, process 500 may include inserting the tube assembly into the second interior volume of the cladding to form a fiber preform (block 550). For example, the optical fiber manufacturing system may insert the tube assembly into the second interior volume to form the fiber preform, as described above.

As further shown in FIG. 5, process 500 may include drawing the fiber preform from a furnace at the drawing temperature and at a drawing tension to form the anti-resonant hollow core optical fiber (block 560). In the anti-resonant hollow core optical fiber, the plurality of capillary tubes may be arranged in a final ring formation to define a hollow core configured to confine light. For example, the optical fiber manufacturing system may draw the fiber preform from the furnace at the drawing temperature and at the drawing tension to form the anti-resonant hollow core optical fiber, as described above.

Process 500 may include additional implementations, such as any single implementation or any combination of implementations described below and/or in connection with one or more other processes described elsewhere herein.

In a first implementation, the plurality of capillary tubes of the anti-resonant hollow core optical fiber are separated by final gaps such that no capillary tube is in contact with another capillary tube.

In a second implementation, the final gaps are smaller than the initial gaps.

The method of claim 15, wherein, after drawing the fiber preform, the outer circumferential surface has a final outer circumferential dimension that is smaller than the initial outer circumferential dimension, and a final inner circumferential dimension that is smaller than the initial inner circumferential dimension.

In a third implementation, drawing the fiber preform causes the second interior volume to partially collapse.

The method of claim 15, wherein, during drawing the fiber preform, a difference in viscosity, at the drawing temperature, between the cladding material and the tube material prevents the plurality of capillary tubes from coming into contact with each other.

In a fourth implementation, drawing the fiber preform includes maintaining an overpressure in the plurality of capillary tubes to prevent a collapse of the plurality of capillary tubes.

In a fifth implementation, drawing the fiber preform includes maintaining an overpressure in the hollow core or in the first interior volume to prevent the mid-draw contact of the plurality of capillary tubes.

In a sixth implementation, the plurality of capillary tubes of the anti-resonant hollow core optical fiber are configured to guide light within a light guiding region of the hollow core, and wherein the hollow core is defined by negative curvatures of the plurality of capillary tubes, the negative curvatures facing inwardly toward a center of the hollow core.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: An anti-resonant hollow core optical fiber, comprising: a cladding having an outer circumferential surface and an inner circumferential surface that defines an interior volume, wherein the cladding is made of a cladding material; and a plurality of capillary tubes arranged within the interior volume, in a ring formation, wherein the plurality of capillary tubes are coupled to the inner circumferential surface of the cladding and define a hollow core, wherein the plurality of capillary tubes are separated by gaps such that no capillary tube is in contact with another capillary tube, wherein the plurality of capillary tubes are made of a tube material that is different from the cladding material, wherein the cladding material has a first viscosity at a relative temperature, wherein the tube material has a second viscosity at the relative temperature, and wherein the first viscosity is lower than the second viscosity.

Aspect 2: The anti-resonant hollow core optical fiber of Aspect 1, wherein the relative temperature is a drawing temperature.

Aspect 3: The anti-resonant hollow core optical fiber of any of Aspects 1-2, wherein the cladding material has a first softening point, wherein the tube material has a second softening point, and wherein the first softening point is lower than the second softening point.

Aspect 4: The anti-resonant hollow core optical fiber of any of Aspects 1-3, wherein the plurality of capillary tubes are configured to guide light within the hollow core, and wherein the hollow core is defined by negative curvatures of the plurality of capillary tubes, the negative curvatures facing inwardly toward a center of the hollow core.

Aspect 5: The anti-resonant hollow core optical fiber of Aspect 4, wherein the plurality of capillary tubes are anti-resonant tubes that are configured to guide the light based on an anti-resonant effect provided by the plurality of capillary tubes.

Aspect 6: The anti-resonant hollow core optical fiber of any of Aspects 1-5, wherein the plurality of capillary tubes are configured to confine light within a confinement region of the hollow core, and wherein the confinement region of the hollow core is defined by negative curvatures of the plurality of capillary tubes, the negative curvatures facing inwardly toward a center of the hollow core.

Aspect 7: The anti-resonant hollow core optical fiber of any of Aspects 1-6, wherein the cladding material is doped silica glass and the tube material is pure silica glass.

Aspect 8: The anti-resonant hollow core optical fiber of any of Aspects 1-7, further comprising: an assembly hollow tube arranged within the interior volume and coupled to the inner circumferential surface of the cladding, wherein the assembly hollow tube defines a second interior volume, wherein the plurality of capillary tubes are arranged within the second interior volume of the assembly hollow tube and are coupled to an interior surface of the assembly hollow tube.

Aspect 9: The anti-resonant hollow core optical fiber of Aspect 8, wherein the assembly hollow tube is made of a material that has a higher viscosity, at the relative temperature, than the first viscosity, at the relative temperature.

Aspect 10: An anti-resonant hollow core optical fiber, comprising: a cladding having an outer circumferential surface and an inner circumferential surface that defines a first interior volume, wherein the cladding is made of a cladding material; an assembly hollow tube arranged within the first interior volume and coupled to the inner circumferential surface of the cladding, wherein the assembly hollow tube defines a second interior volume; and a plurality of non-contacting tubes arranged within the second interior volume, in a ring formation, wherein the plurality of non-contacting tubes are coupled to an interior surface of the assembly hollow tube and define a hollow core, wherein the plurality of non-contacting tubes are separated by gaps such that no non-contacting tube is in contact with another non-contacting tube, wherein the plurality of non-contacting tubes are made of a tube material that is different from the cladding material, wherein the cladding material has a first softening point, wherein the tube material has a second softening point, and wherein the first softening point is lower than the second softening point.

Aspect 11: The anti-resonant hollow core optical fiber of Aspect 10, wherein the plurality of non-contacting tubes are configured to guide light within a light guiding region of the hollow core, and wherein the hollow core is defined by negative curvatures of the plurality of non-contacting tubes, the negative curvatures facing inwardly toward a center of the hollow core.

Aspect 12: The anti-resonant hollow core optical fiber of any of Aspects 10-11, wherein the assembly hollow tube is made of a material that has a higher softening point than the first softening point.

Aspect 13: The anti-resonant hollow core optical fiber of any of Aspects 10-12, wherein the cladding material is doped silica glass and the tube material is pure silica glass.

Aspect 14: The anti-resonant hollow core optical fiber of any of Aspects 10-13, wherein the hollow core is an air-filled core.

Aspect 15: A method of manufacturing an anti-resonant hollow core optical fiber, the method comprising: providing an assembly hollow tube having a first interior volume; forming a plurality of capillary tubes, the plurality of capillary tubes being made of a tube material; inserting the plurality of capillary tubes into the first interior volume of the assembly hollow tube to form a tube assembly, wherein the plurality of capillary tubes are coupled to an interior surface of the assembly hollow tube in an initial ring formation, and wherein the plurality of capillary tubes are separated by initial gaps such that no capillary tube is in contact with another capillary tube; providing a cladding having an outer circumferential surface with an initial outer circumferential dimension and an initial inner circumferential surface with an initial inner circumferential dimension, wherein the initial inner circumferential surface defines a second interior volume, and wherein the cladding is made of a cladding material that has a lower viscosity at a drawing temperature than the tube material; inserting the tube assembly into the second interior volume to form a fiber preform; and drawing the fiber preform from a furnace at the drawing temperature and at a drawing tension to form the anti-resonant hollow core optical fiber, wherein, in the anti-resonant hollow core optical fiber, the plurality of capillary tubes are arranged in a final ring formation to define a hollow core configured to confine light.

Aspect 16: The method of Aspect 15, wherein the plurality of capillary tubes of the anti-resonant hollow core optical fiber are separated by final gaps such that no capillary tube is in contact with another capillary tube.

Aspect 17: The method of Aspect 16, wherein the final gaps are smaller than the initial gaps.

Aspect 18: The method of any of Aspects 15-17, wherein, after drawing the fiber preform, the outer circumferential surface has a final outer circumferential dimension that is smaller than the initial outer circumferential dimension, and a final inner circumferential dimension that is smaller than the initial inner circumferential dimension.

Aspect 19: The method of any of Aspects 15-18, wherein drawing the fiber preform causes the second interior volume to partially collapse.

Aspect 20: The method of any of Aspects 15-19, wherein, during drawing the fiber preform, a difference in viscosity, at the drawing temperature, between the cladding material and the tube material prevents the plurality of capillary tubes from coming into contact with each other.

Aspect 21: The method of any of Aspects 15-20, wherein drawing the fiber preform includes: maintaining an overpressure in the plurality of capillary tubes to prevent a collapse of the plurality of capillary tubes.

Aspect 22: The method of Aspects 15-21, wherein drawing the fiber preform includes: maintaining an overpressure in the first interior volume to prevent a mid-draw contact of the plurality of capillary tubes.

Aspect 23: The method of any of Aspects 15-22, wherein the plurality of capillary tubes of the anti-resonant hollow core optical fiber are configured to guide light within a light guiding region of the hollow core, and wherein the hollow core is defined by negative curvatures of the plurality of capillary tubes, the negative curvatures facing inwardly toward a center of the hollow core.

Aspect 24: An anti-resonant hollow core optical fiber, comprising: a cladding having an outer circumferential surface and an inner circumferential surface that defines an interior volume, wherein the cladding is made of a cladding material; and a plurality of circular capillary tubes arranged within the interior volume, in a ring formation, wherein the plurality of circular capillary tubes are coupled to the inner circumferential surface of the cladding and define a hollow core, wherein the plurality of circular capillary tubes are made of a tube material that is different from the cladding material, wherein the cladding material has a first viscosity at a relative temperature, wherein the tube material has a second viscosity at the relative temperature, and wherein the first viscosity is lower than the second viscosity.

Aspect 25: The anti-resonant hollow core optical fiber of Aspect 24, wherein, in the ring formation, the plurality of circular capillary tubes form a closed ring.

Aspect 26: The anti-resonant hollow core optical fiber of any of Aspects 24-25, wherein, in the ring formation, each circular capillary tube of the plurality of circular capillary tubes is in contact with adjacent circular capillary tubes of the plurality of circular capillary tubes.

Aspect 27: The anti-resonant hollow core optical fiber of any of Aspects 24-26, wherein the plurality of circular capillary tubes are separated by gaps such that no circular capillary tube is in contact with another circular capillary tube.

Aspect 28: A system configured to perform one or more operations recited in one or more of Aspects 1-27.

Aspect 29: An apparatus comprising means for performing one or more operations recited in one or more of Aspects 1-27.

Aspect 30: A non-transitory computer-readable medium storing a set of instructions, the set of instructions comprising one or more instructions that, when executed by a device, cause the device to perform one or more operations recited in one or more of Aspects 1-27.

Aspect 31: A computer program product comprising instructions or code for executing one or more operations recited in one or more of Aspects 1-27.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An anti-resonant hollow core optical fiber, comprising:
a cladding having an outer circumferential surface and an inner circumferential surface that defines an interior volume, wherein at least part of the cladding is made of a cladding material; and
a plurality of capillary tubes arranged within the interior volume, in a ring formation, wherein the plurality of capillary tubes are coupled to the inner circumferential surface of the cladding and define a hollow core,
wherein the plurality of capillary tubes are separated by gaps such that no capillary tube is in contact with another capillary tube,
wherein the plurality of capillary tubes are made of a tube material that is different from the cladding material.

2. The anti-resonant hollow core optical fiber of claim 1, wherein the cladding material has a first viscosity at a relative temperature,
wherein the tube material has a second viscosity at the relative temperature, and
wherein the first viscosity is lower than the second viscosity.

3. The anti-resonant hollow core optical fiber of claim 2, wherein the relative temperature is a drawing temperature.

4. The anti-resonant hollow core optical fiber of claim 1, wherein the cladding material has a first softening point,
wherein the tube material has a second softening point, and
wherein the first softening point is lower than the second softening point.

5. The anti-resonant hollow core optical fiber of claim 1, wherein the plurality of capillary tubes are configured to guide light within the hollow core, and
wherein the hollow core is defined by negative curvatures of the plurality of capillary tubes, the negative curvatures facing inwardly toward a center of the hollow core.

6. The anti-resonant hollow core optical fiber of claim 4, wherein the plurality of capillary tubes are anti-resonant tubes that are configured to guide the light based on an anti-resonant effect provided by the plurality of capillary tubes.

7. The anti-resonant hollow core optical fiber of claim 1, wherein the plurality of capillary tubes are configured to confine light within a confinement region of the hollow core, and
wherein the confinement region of the hollow core is defined by negative curvatures of the plurality of capillary tubes, the negative curvatures facing inwardly toward a center of the hollow core.

8. The anti-resonant hollow core optical fiber of claim 1, wherein the cladding material is doped silica glass and the tube material is pure silica glass.

9. The anti-resonant hollow core optical fiber of claim 1, further comprising:
an assembly hollow tube arranged within the interior volume and coupled to the inner circumferential surface of the cladding, wherein the assembly hollow tube defines a second interior volume,
wherein the plurality of capillary tubes are arranged within the second interior volume of the assembly hollow tube and are coupled to an interior surface of the assembly hollow tube.

10. The anti-resonant hollow core optical fiber of claim 8, wherein the cladding material has a first viscosity at a relative temperature,
wherein the tube material has a second viscosity at the relative temperature,
wherein the first viscosity is lower than the second viscosity, and
wherein the assembly hollow tube is made of a material that has a higher viscosity, at the relative temperature, than the first viscosity, at the relative temperature.

11. An anti-resonant hollow core optical fiber, comprising:
a cladding having an outer circumferential surface and an inner circumferential surface that defines a first interior volume, wherein at least part of the cladding is made of a cladding material;
an assembly hollow tube arranged within the first interior volume and coupled to the inner circumferential surface of the cladding, wherein the assembly hollow tube defines a second interior volume; and
a plurality of non-contacting tubes arranged within the second interior volume, in a ring formation, wherein the plurality of non-contacting tubes are coupled to an interior surface of the assembly hollow tube and define a hollow core,
wherein the plurality of non-contacting tubes are separated by gaps such that no non-contacting tube is in contact with another non-contacting tube,
wherein the plurality of non-contacting tubes are made of a tube material that is different from the cladding material.

12. The anti-resonant hollow core optical fiber of claim 11, wherein the cladding material has a first softening point,
wherein the tube material has a second softening point, and
wherein the first softening point is lower than the second softening point.

13. The anti-resonant hollow core optical fiber of claim 11, wherein the plurality of non-contacting tubes are configured to guide light within a light guiding region of the hollow core, and
wherein the hollow core is defined by negative curvatures of the plurality of non-contacting tubes, the negative curvatures facing inwardly toward a center of the hollow core.

14. The anti-resonant hollow core optical fiber of claim 11, wherein the cladding material has a first softening point,
wherein the tube material has a second softening point,
wherein the first softening point is lower than the second softening point, and
wherein the assembly hollow tube is made of a material that has a higher softening point than the first softening point.

15. The anti-resonant hollow core optical fiber of claim 11, wherein the cladding material is doped silica glass and the tube material is pure silica glass.

16. The anti-resonant hollow core optical fiber of claim 11, wherein the hollow core is an air-filled core.

17. A method of manufacturing an anti-resonant hollow core optical fiber, the method comprising:
providing an assembly hollow tube having a first interior volume;
forming a plurality of capillary tubes, the plurality of capillary tubes being made of a tube material;
inserting the plurality of capillary tubes into the first interior volume of the assembly hollow tube to form a tube assembly, wherein the plurality of capillary tubes are coupled to an interior surface of the assembly hollow tube in an initial ring formation, and wherein the plurality of capillary tubes are separated by initial gaps such that no capillary tube is in contact with another capillary tube;
providing a cladding having an outer circumferential surface with an initial outer circumferential dimension and an initial inner circumferential surface with an initial inner circumferential dimension, wherein the initial inner circumferential surface defines a second interior volume, and wherein at least part of the cladding is made of a cladding material that has a lower viscosity at a drawing temperature than the tube material;
inserting the tube assembly into the second interior volume to form a fiber preform; and
drawing the fiber preform from a furnace at the drawing temperature and at a drawing tension to form the anti-resonant hollow core optical fiber,
wherein, in the anti-resonant hollow core optical fiber, the plurality of capillary tubes are arranged in a final ring formation to define a hollow core configured to confine light.

18. The method of claim 17, wherein the plurality of capillary tubes of the anti-resonant hollow core optical fiber are separated by final gaps such that no capillary tube is in contact with another capillary tube.

19. The method of claim 18, wherein the final gaps are smaller than the initial gaps.

20. The method of claim 17, wherein, after drawing the fiber preform, the outer circumferential surface has a final outer circumferential dimension that is smaller than the initial outer circumferential dimension, and a final inner circumferential dimension that is smaller than the initial inner circumferential dimension.

21. The method of claim 17, wherein drawing the fiber preform causes the second interior volume to partially collapse.

22. The method of claim 17, wherein, during drawing the fiber preform, a difference in viscosity, at the drawing temperature, between the cladding material and the tube material prevents the plurality of capillary tubes from coming into contact with each other.

23. The method of claim 17, wherein drawing the fiber preform includes:
maintaining an overpressure in the plurality of capillary tubes to prevent a collapse of the plurality of capillary tubes.

24. The method of claim 17, wherein drawing the fiber preform includes:
maintaining an overpressure in the first interior volume to prevent a mid-draw contact of the plurality of capillary tubes.

25. The method of claim 17, wherein the plurality of capillary tubes of the anti-resonant hollow core optical fiber are configured to guide light within a light guiding region of the hollow core, and
wherein the hollow core is defined by negative curvatures of the plurality of capillary tubes, the negative curvatures facing inwardly toward a center of the hollow core.

26. An anti-resonant hollow core optical fiber, comprising:
a cladding having an outer circumferential surface and an inner circumferential surface that defines an interior volume, wherein at least part of the cladding is made of a cladding material; and
a plurality of circular capillary tubes arranged within the interior volume, in a ring formation, wherein the plurality of circular capillary tubes are coupled to the inner circumferential surface of the cladding and define a hollow core,
wherein the plurality of circular capillary tubes are made of a tube material that is different from the cladding material.

27. The anti-resonant hollow core optical fiber of claim 26, wherein the cladding material has a first viscosity at a relative temperature,
wherein the tube material has a second viscosity at the relative temperature, and
wherein the first viscosity is lower than the second viscosity.

28. The anti-resonant hollow core optical fiber of claim 27, wherein, in the ring formation, the plurality of circular capillary tubes form a closed ring.

29. The anti-resonant hollow core optical fiber of claim 27, wherein, in the ring formation, each circular capillary tube of the plurality of circular capillary tubes is in contact with adjacent circular capillary tubes of the plurality of circular capillary tubes.

30. The anti-resonant hollow core optical fiber of claim 27, wherein the plurality of circular capillary tubes are separated by gaps such that no circular capillary tube is in contact with another circular capillary tube.
